(19) United States
(12) Patent Application Publication
(10) Pub. No.: US 2010/0070901 A1
(43) Pub. Date: Mar. 18, 2010

(54) Systems and Methods for In-Line Viewing of Multiple File Types over a Network Using a Single Player

(76) Inventors: James Skinner, Singapore (SG); Michael Hewitt, South Jordan, UT (US); Doug Weber, Salt Lake City, UT (US); Gib Reimschussel, Holladay, UT (US); D. Christian Harrison, Salt Lake City, UT (US); Steve Conlee, Pleasant Grove, UT (US); Eugene Skinner, Tokyo (JP)

Correspondence Address: KIRTON AND MCCONKIE, 60 EAST SOUTH TEMPLE,, SUITE 1800, SALT LAKE CITY, UT, 84111, US

(21) Appl. No.: 12/211,472

(22) Filed: Sep. 16, 2008

(51) Int. Cl. G06F 3/048

(52) U.S. Cl. 715/771

(57) ABSTRACT

Systems and methods for in-line viewing of files of multiple types, including files in mixed file formats, utilizing a single viewer or player are described. A single viewer is capable of displaying multiple file formats of both static and dynamic nature. The viewer may be used to display a wide variety of content accessible from a single web page, and web designers need only embed the single viewer to access many content types. The viewer receives a selection of a file to access and identifies the file type of the selected file. The viewer provides proper controls associated with the file type and displays or provides other access to the selected file. Thus the viewer provides a more streamlined experience to the user and simplifies accessing files of various file types. The viewer may be embedded in a web page or may be provided in a pop-up or modal window.

### BACKGROUND OF THE INVENTION

1. Field of the Invention

The present invention relates to systems and methods for viewing documents over a network, and more particularly to systems and methods for in-line viewing of files of multiple types, including files in mixed file formats, utilizing a single viewer or player.

2. Background and Related Art

Computer networks, including networks of sizes from local to worldwide (such as the Internet) have provided new mechanisms to distribute information and media from one person or user to another. However, the distribution over networked computers has been limited in many regards. For example, while many different file and media types, including static and dynamic content, can be distributed over networks, current systems are limited in their ability to seamlessly display or otherwise provide access to the multiple file types.

For instance, a user accessing an audio file is typically required to utilize a media player specifically configured to play the desired audio file type. Some audio file types are proprietary, and can only be accessed using certain types of players. If the user decides to switch to accessing (i.e. viewing) a video file, the user typically must switch to a player designed to play video files of the type the user desires to view. If the user then decides to view a portable document format (PDF) file, the user then has to switch to a viewer capable of displaying the PDF file. Nearly endless examples could be provided, but similar difficulties are encountered when switching between word processor documents and files, spreadsheet documents and files, slideshow presentation files, still graphical files, enriched-content files, etc., in addition to the other types of files discussed above.

One difficulty presented by currently-available solutions and the various types of files that can be distributed over networks is that each of the various players or viewers necessary to view or otherwise access the various file types must all be installed and available on a computer before the files can be accessed, played, or viewed. It is fairly common for a user to desire to access a particular file only to discover that access is not possible without first downloading and installing a particular viewer, player, or other application over the network or installing a particular viewer, player, or other application from some form of storage media. Even the installation of the necessary players/viewers can present problems: large numbers of players/viewers installed on a system take up valuable resources; as the number of viewers/players installed on a particular computer system increases, the potential for undesirable interactions between programs increases; and the various viewers/players can interfere with each other in undesirable ways, such as by competing with each other to be the designated program to open a particular file type.

These problems may be exacerbated during network-based delivery of files and information. For example, a number of files may be delivered to a user in a single session, and those files may include files of various types. Using currently-available players/viewers, the transition between files may be difficult and interrupted at best, as a different player/viewer must be initialized and used to display the each different file type. Even when several of the files are of the same type, player/viewer changes may be just as frequent based on the order the files are presented: if two files of one type are divided by a file of another type, transitions are still necessary. At worst, the user experience can be highly frustrating, as installation of additional viewers/players is required. Thus, currently available systems have proven unsatisfactory at meeting user expectation: when viewing files over a network, such as using a browser, users have come to expect a seamless and uninterrupted experience.

Many of these problems even continue when accessing files previously-obtained over a network or by other means and being viewed locally. Therefore, the currently-available systems and services for distribution of files over networks are limited.

### BRIEF SUMMARY OF THE INVENTION

Implementation of the present invention provides systems and methods for in-line viewing of files over a network such as the Internet, and more particularly provides systems and methods for in-line viewing of files of multiple types, including files in mixed file formats, utilizing a single viewer or player. Unlike existing players or viewers that can only play one file format or formats having similar characteristics, implementation of the present invention provides a single player/viewer capable of displaying multiple file formats of both static and dynamic nature. Static file formats, in the sense referred to herein, include those formats not including a time component, and include file formats such as still images, spreadsheets, documents, etc., and includes file formats having single pages or multiple pages, scrolling to access additional portions of the file, or other features to access the files where the displayed or accessed content of the file is not time-dependent. Dynamic file formats, in the sense referred to herein, include video formats, audio formats, timed slideshows, etc. where access of the file format includes a time-dependent component.

Implementation of the invention provides a viewer capable of displaying multiple formats including static formats, dynamic formats, and combinations of static and dynamic formats. Implementation of the invention may include a viewer configured to provide local access to files and/or alternatively configured to display, play, or otherwise permit access to files over a network such as the Internet, such as through a user's browser. In this way, the viewer/player may be used to display a wide variety of content accessible from a single web page, wherein in the past, web designers needed to embed various players into their pages depending on the nature of the content to be played, viewed, or otherwise accessed.

Implementation of the invention provide a viewer that receives a selection of a file to access and that identifies the file type of the selected file by examining the file extension or other file type information included in the file. The viewer then determines whether the file is of a dynamic or static nature or some combination thereof. If the file is of a static nature, the viewer reads the file and renders a static image that may be scrollable, may have pagination, and may be scalable/zoomable. If the file is of a dynamic nature, the viewer reads the file and outputs the information at a given sampling or frame rate, either at a rate embodied in the original file or at a rate set by the viewer or selected by the user operating the viewer. Thus the viewer provides a more streamlined experience to the user and simplifies accessing files of various file types. When utilized over a network, such as in a browser, the viewer may be embedded in a web page or may be provided in a pop-up or modal window.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative computer system for use with embodiments of the invention;

FIG. 2 shows a representative networked computer environment as used by embodiments of the invention;

FIG. 3 shows a representative screen shot of a representative web display for use with an embodiment of the invention;

FIG. 4 shows a representative screen shot of a representative web display for use with an embodiment of the invention;

FIG. 5 shows a representative flow chart illustrating an embodiment of the invention;

FIG. 6 shows a representative screen shot of a representative web display for use with an embodiment of the invention;

FIG. 7 shows a representative screen shot of a representative web display for use with an embodiment of the invention;

FIG. 8 shows a representative viewer display of an embodiment of the invention; and

FIG. 9 shows a representative viewer display of an embodiment of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention provide systems and methods for in-line viewing of files over a network such as the Internet and more particularly provide systems and methods for in-line viewing of files of multiple types, including files in mixed file formats, utilizing a single viewer or player. Unlike existing players or viewers that can only play one file format or formats having similar characteristics, embodiments of the present invention provide a single player/viewer capable of displaying multiple file formats of both static and dynamic nature. Static file formats, in the sense referred to herein, include those formats not including a time component, and include file formats such as still images, spreadsheets, documents, etc., and includes file formats having single pages or multiple pages (e.g. PDF documents, word-processor documents, spreadsheets, etc.), scrolling to access additional portions of the file (e.g. large spreadsheets, paginated documents, etc.), or other features to access the files where the displayed or accessed content of the file is not time-dependent. Dynamic file formats, in the sense referred to herein, include video formats, audio formats, timed slideshows, etc. where access of the file format includes a time-dependent component.

Embodiments of the inventive viewer are capable of displaying multiple formats including static formats, dynamic formats, and formats having both static and dynamic elements. Some embodiments may be configured to provide local access to files. Some embodiments are also or alternatively configured to display, play, or otherwise permit access to files over a network such as the Internet, such as through a user's browser, as is disclosed in co-pending application, U.S. Ser. No. ______, filed on the same day as this application, which is incorporated herein by reference in its entirety for all it discloses. In this way, the viewer/player may be used to display a wide variety of content accessible from a single web page, wherein in the past, web designers needed to embed various players into their pages depending on the nature of the content to be played, viewed, or otherwise accessed.

Embodiments of the inventive viewer receive a selection of a file to access and identify the file type of the selected file by examining the file extension or other file type information included in the file. The viewer then determines whether the file is of a dynamic or static nature. If the file is of a static nature, the viewer reads the file and renders a static image that may be scrollable, may have pagination, and may be scalable/zoomable. If the file is of a dynamic nature, the viewer reads the file and outputs the information at a given sampling or frame rate, either at a rate embodied in the original file or at a rate set by the viewer or selected by the user operating the viewer. Thus the viewer provides a more streamlined experience to the user and simplifies accessing files of various file types.

Embodiments of the invention may be particularly useful for viewing or otherwise accessing groups of files having multiple file formats, such as over a network. With the increasing delivery of information and other content over networks such as the Internet, and with the increasing number of types of files that can be delivered over networks, it is becoming increasingly common for files of different types to be associated with one another, such as with an intent that the files be viewed or otherwise accessed together or in conjunction with each other (e.g. serially). For example, this may occur with online lessons presented by schools, etc., where a lesson includes an audio or video component as well as a textual component and possibly other components. Another example includes an enriched electronic book that may now include an audio or video component. These examples are given by way of illustration only, and are not intended to be limiting in any way.

Thus, in some instances, files to be delivered may be organized into groups or lists of related files, thus forming one or more products. The file or files in a single product (e.g. group or list) may be of one file type or may include files of various formats. Embodiments of the invention provide a viewer that is capable of displaying files of any type contained in the product, thereby enhancing the user's experience in viewing or otherwise accessing the files within the product. Thus, embodiments of the invention are particularly helpful in accessing, viewing, playing, listening to, etc. multi-format content that may be published online as one or more products.

A user wishing to view one or more products or a file within a product selects the product/file to access. When access to a file is provided, a determination is made as to the type of file to be accessed (e.g. displayed, played, etc.), and rather than select a player or viewer appropriate for the file type to display, play, or otherwise provide access to the file for the user, the viewer of embodiments of the present invention simply provides access to the selected file after determining the file type of the accessed file. As each subsequent file in the product is to be accessed, the determination of the appropriate file type is repeated and access to the file is provided accordingly. Access to the files may be provided on a streamed basis or may be provided using local (e.g. downloaded) files, or some combination of the two.

Embodiments of the present invention embrace products including various media and file types. Media/file types are designations that may be applied to one or more components describing how the media/file is to be consumed, and the various types may typically utilize different media players or viewers when not being played by players according to the embodiments of the present invention. Examples of various types include video, audio, graphical, textual, etc. Embodiments of the present invention further embrace products including a wide variety of categories of files/media, and categories may be understood to refer to the content of the media/file. Examples of various categories of media include: function, history, comedy, action, adventure, instructional, tutorial, self-improvement, etc.

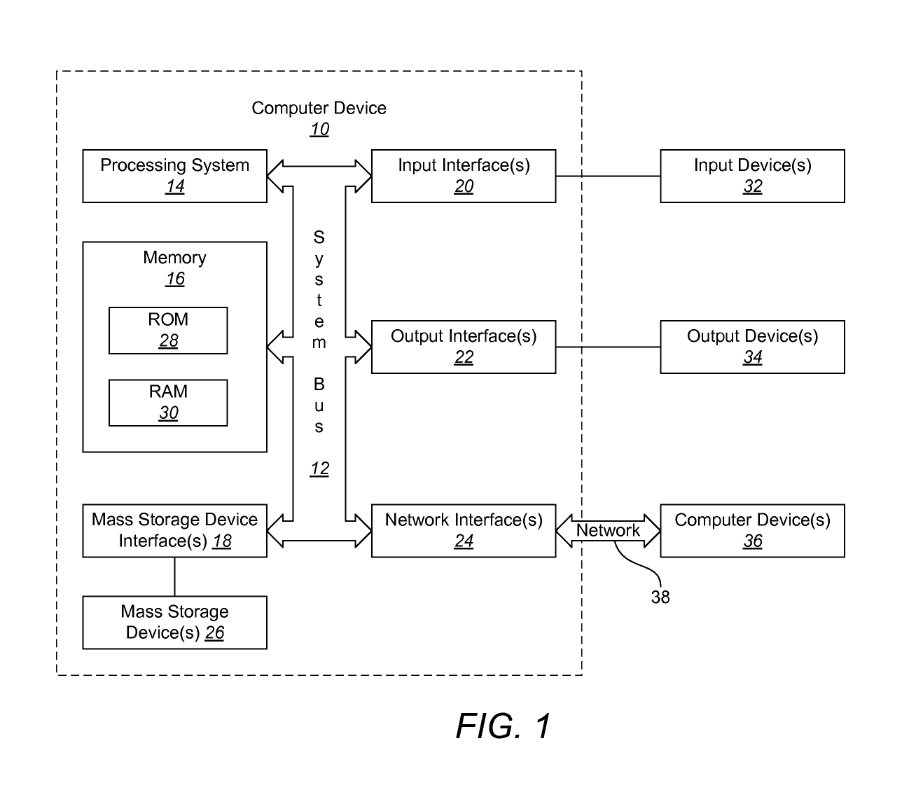

As at least some embodiments embrace the use of networked computers and electronic devices or other computer-based systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, consumer electronic devices, and other such electronic environments.

Embodiments of the present invention embrace one or more computer-readable media, wherein each medium may be configured to include or includes thereon data or computer-executable instructions for manipulating data. The computer-executable instructions include data structures, objects, programs, routines, or other program modules that may be accessed by a processing system, such as one associated with a general-purpose computer capable of performing various different functions or one associated with a special-purpose computer capable of performing a limited number of functions. Computer-executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), digital versatile disc read-only memory (“DVD-ROM”) or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, a smart phone, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection connected to a physical computer-readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, optical disk drives, and flash drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

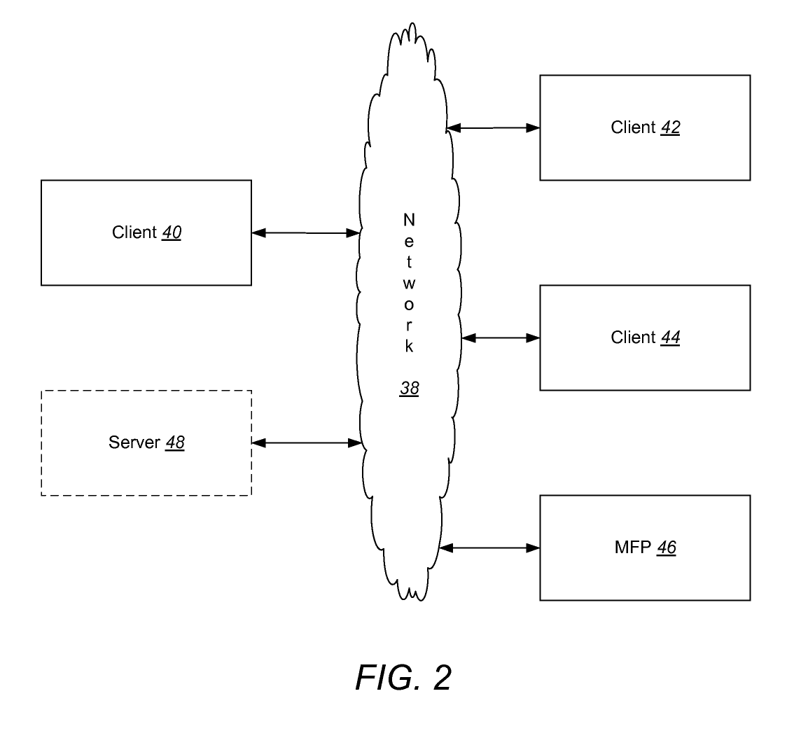

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and to one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Embodiments of the present invention provide systems and methods for in-line viewing of files over a network such as the Internet and more particularly to systems and methods for in-line viewing of files of multiple types, including files in mixed file formats, utilizing a single viewer or player. Unlike existing file viewers that only play or display one type of file or group of related file types (e.g. the Flash™ players plays only Flash™ files), file viewers or players in accordance with embodiments of the invention (hereinafter referred to as viewers or viewer, which should be taken to mean any browser plugin or program, or any standalone program configured to provide access to files of multiple file types) provide access to many file types. The file types accessed by viewers in accordance with embodiments of the invention include both static-type files/content, dynamic-type files/content, and files having mixed static and dynamic content.

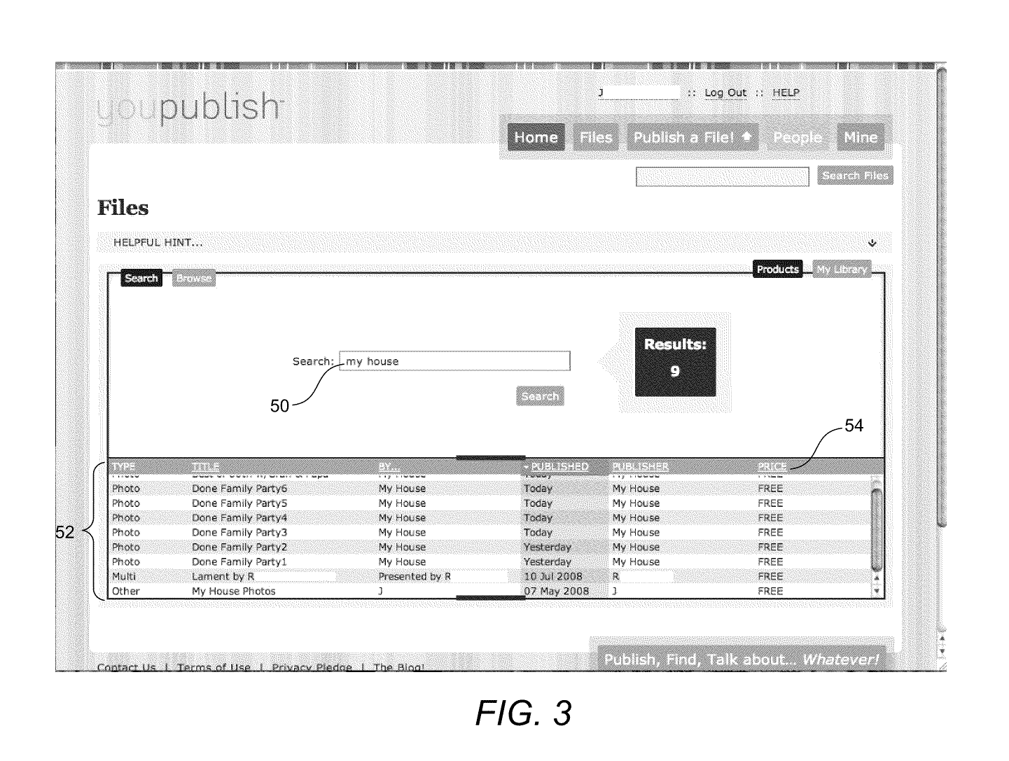

That the embodiments of the invention may be better understood, one embodiment of the invention will be discussed, the embodiment being a viewer embedded in a webpage. Therefore, FIG. 3 provides a representative screen shot showing a file distribution webpage for distribution of user-uploaded and online-published files of varying types. In the screen shot of FIG. 3, a file search has been initiated using a search term input location 50, and a result list 52 has been returned as a result of a search. In the illustrated webpage, some files may be purchased while others are freely distributed, and therefore, a price indicator 54 is provided showing pricing of the file results returned in the result list 52. The results in the result list 54 may be individual files or may include groups or lists of associated files (e.g. products), and the results (whether individual files or groups/lists) in the results list 54 may include files of multiple types.

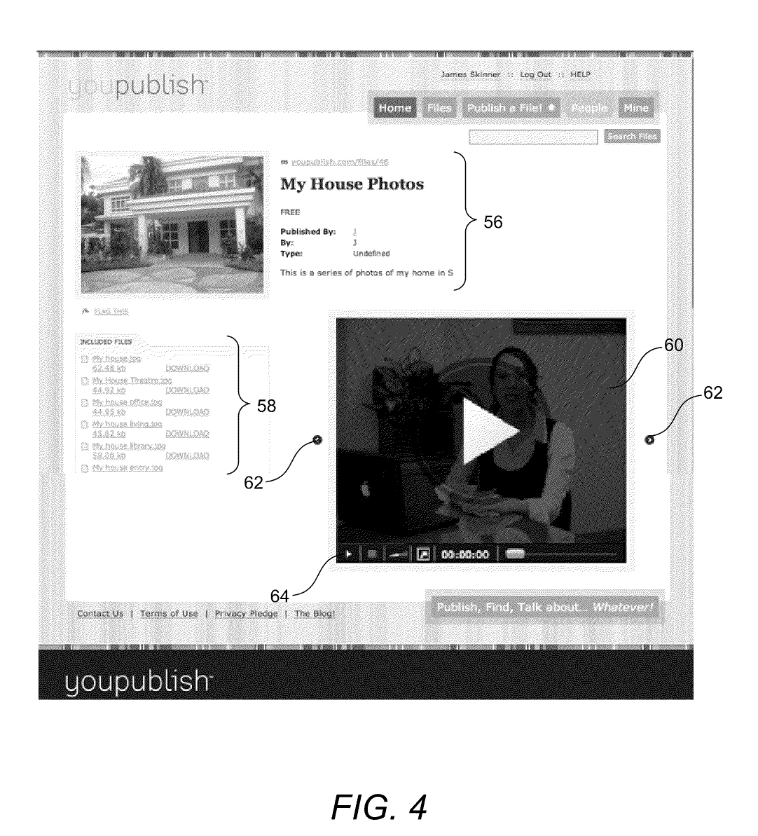

After the user views the results list 54, the user may select a particular result (file or group of files/product) for viewing, playing, or other access. When the user selects a file or group of files for access, a display such as that illustrated in FIG. 4 may be presented. Alternatively, the viewer may open without the additional information displayed in FIG. 4, and may begin providing access to the selected file or files. FIG. 4 shows a view of an illustrative webpage such as might be displayed upon selecting a product (e.g. group of associated files). The webpage display includes a product information section 56, a product contents section 58, and a viewer 60. The webpage display also may include file navigation buttons 62 that may permit the user to navigate between consecutive files within the group of files. As the navigation buttons 62 are selected, a next or a previous file in the group of files is opened and displayed, played, or otherwise accessed through the viewer 60. In some embodiments, the user can bring up any file within the group in the viewer 60 by selecting the file from the product contents section 58.

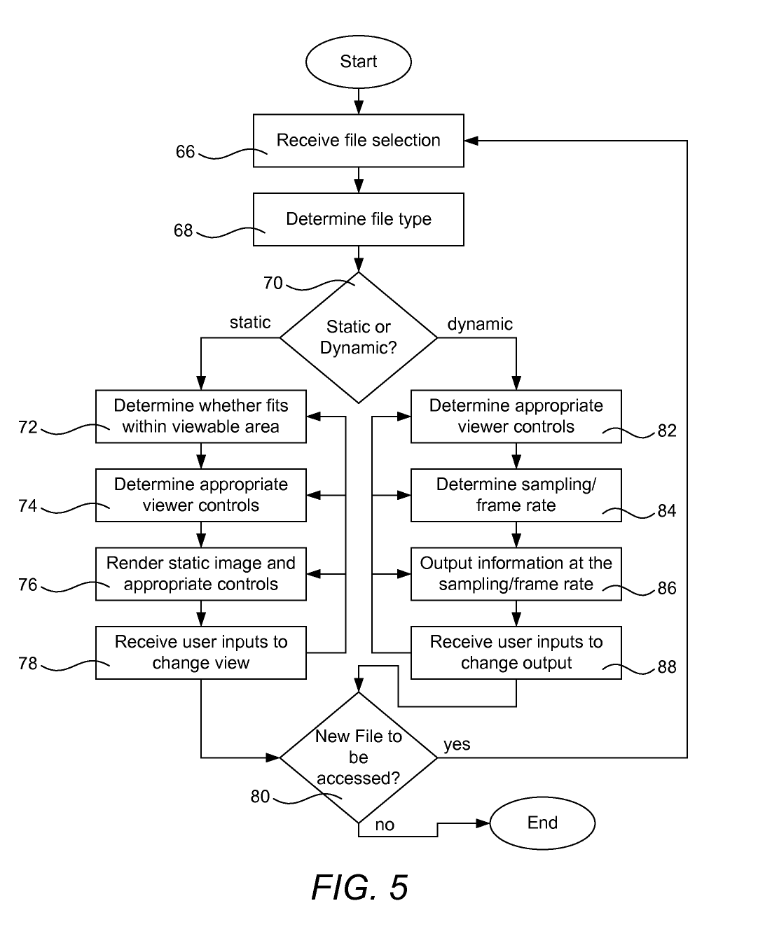

FIG. 5 illustrates processes that may be effectuated by the viewer 60 as a file is opened and displayed or otherwise accessed by the viewer 60. Execution begins at step 66, where the viewer 60 receives a file selection for opening and displaying/providing access/etc. At step 68, as each file is selected, the viewer 60 identifies the file type of the file selected by the user to be viewed, played, accessed, etc. The viewer 60 may do this by looking at a file extension of the selected file or by examining other file type information included in the selected file. After determining the file type, execution proceeds to decision block 70, whereupon the viewer 60 determines whether the file/file type is static or dynamic. If the viewer 60 determines that the file/file type is static, execution proceeds to steps 72 and 74, where the viewer 60 determines whether the file to be played/displayed/viewed/etc. fits within a viewable area of the viewer 60 and determines appropriate viewer controls to be displayed while the file is accessed. The determination of the appropriate viewer controls for display may depend on the file type as well as on whether the file fits within the viewable area or not.

For example, suppose the viewer 60 is opening a spreadsheet-type document. If the viewer 60 determines that the entire document fits within a viewable area of the viewer 60, the viewer may determine that no viewer controls are necessary. Alternately, the viewer may still provide some viewer controls, such as scaling/zoom controls. If, however, the viewer 60 determines that the document is larger than the displayable area, either after a zoom-in or otherwise, the viewer 60 may provide vertical and/or horizontal scroll bars to permit the user to move the view to non-visible portions of the document. If the viewer 60 determines that the document has multiple pages, the viewer 60 could also provide next/previous page buttons, first/last page buttons, and/or a page number entry for quick navigation to a particular page. The foregoing are merely examples of viewer controls that may be provided for one particular type of document/file. Additional/alternate controls may be provided for this or other static file types.

The viewer 60, when displaying/accessing static files in some embodiments, determines not to provide or display viewer controls typically associated with dynamic file types. Such controls may include play, pause, fast-forward, rewind, stop, slow-play, frame advance, etc. Similarly, when dynamic files are being played, some viewer controls typically associated with static file types are not displayed. Such controls may include zoom/scaling controls, horizontal/vertical scroll bars, pagination-related buttons/controls, etc. In some alternative embodiments, many or all viewer controls are always displayed, but viewer controls not applicable to the file type being displayed are inactivated so that the user cannot select them. In some embodiments, one or more viewer controls are only active at certain times, such as when the user clicks on or hovers a pointer over a portion of the viewer 60.

The determination of appropriate viewer controls to display may also be based on limitations associated with a certain file. For example, with respect to a multi-page document as part of a lesson, a teacher may desire that students progress through the document page by page, and therefore places a limitation on the file that prevents skipping to the last page of the document directly. Another file may have a limitation preventing zooming or scaling features, and therefore the viewer 60 would not display those types of viewer controls. Similar limitations could be put on dynamic files, such as elimination of fast-forward/rewind buttons, etc. Another type of limitation could be associated with files requiring purchase: the viewer could display the first page of a document as a free sample, with any page-access viewer controls disabled until the user purchases the document, for example. Thus many factors may be considered when determining the appropriate viewer controls.

Once the appropriate viewer controls, if any have been determined, execution proceeds to step 76, where the viewer 60 renders the static image and the appropriate controls. The static image may be of a bit map, vector-based, or other similar nature. This rendering may be within the user's browser when delivery is over the network (e.g. streaming), may be by way of a separate pop-up or modal window, or may be as a stand-alone viewer. At step 78, the viewer 60 receives user input (e.g. through the provided viewer controls) to change the displayed view, whereupon execution loops back to any one of steps 72, 74, or 76, whichever is appropriate, to make the necessary changes to properly provide the file to the user.

Once viewing of the file is complete, execution proceeds to decision block 80, where a determination is made as to whether to access a new file. If a new file is to be accessed (e.g. selection of one of the file navigation buttons 62 is received), execution loops back to step 66. If not, execution ends or may return to user searches of documents, etc.

If, at decision block 70, it is determined that the file is a dynamic file, execution proceeds to steps 82-88, which are similar to the steps discussed for static files, but are modified to match the nature of the dynamic files. At step 82, the viewer 60 determines the appropriate viewer controls to display 82. At step 84, the viewer 60 determines the sampling or frame rate for output, which may be set by the file itself, by a connection speed of the network when the file is delivered over a network (e.g. streamed), or may be selected by the user. At step 86, the viewer 60 outputs the information/plays the dynamic file at the selected sampling or frame rate, and at step 88, the viewer 60 receives user input to modify the output (e.g. a selection of pause, fast-forward, rewind, etc.) and execution loops back to any of steps 82-86. Execution passes to decision block 80 as discussed above when viewing/playing of the dynamic file is complete.

Although not specifically illustrated in FIG. 5, some embodiments of the viewer 60 may determine that a resizing of the viewer 60 is necessary to adequately display, play, or otherwise access a particular file. Such embodiments automatically resize themselves, within available constraints, to better provide access to the files. Resizing is often desirable for displaying/playing a larger-resolution file than the current resolution/viewable area of the viewer 60, and in instances where the aspect ratio changes between files. Resizing is also often desirable when a smaller-resolution file is to be displayed, so as to better permit displaying of other information, either within a browser window or from other applications in the background. Therefore, embodiments of the invention embrace viewers 60 that automatically self-resize as desired or necessary to display or provide access to the files.

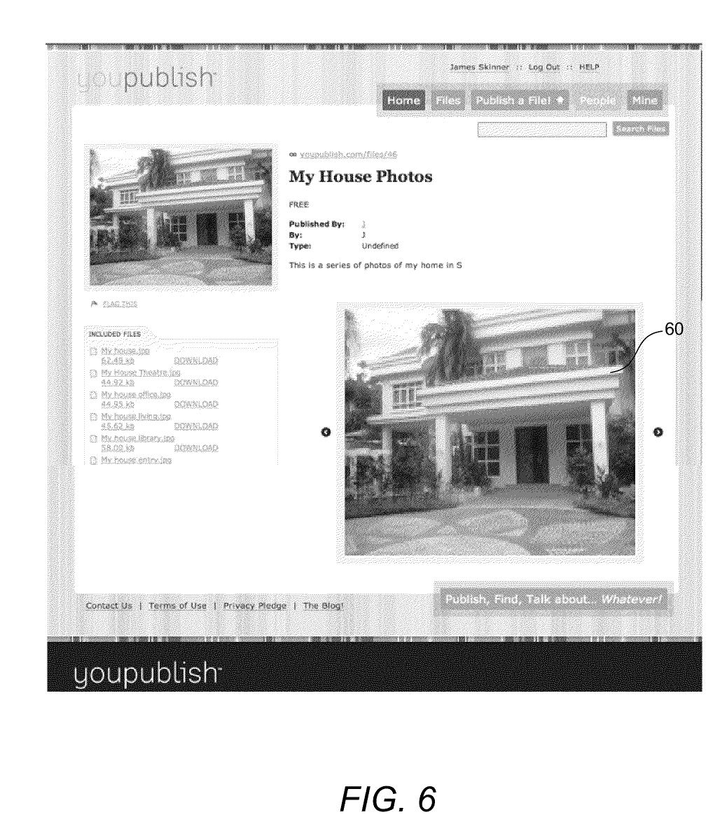

Returning to FIG. 4, the viewer 60 in FIG. 4 is shown as displaying a dynamic-type file. Therefore, the viewer 60 is illustrated as providing a set of viewer controls 64 appropriate for the dynamic-type file, such as play, pause, volume, and a time/progress indicator/slider. In contrast, FIG. 6 shows the viewer 60 displaying a static-type file, where no viewer controls 64 have been provided. In this instance, the desired view has been displayed or the file itself is associated with instructions not to provide any viewer controls 64 that would permit changing the view of the illustrated picture. Alternatively, the display of FIG. 6 could be associated with a viewer 60 displaying either a static-type file or a dynamic-type file, but where the viewer controls 64 are hidden unless the user clicks on the viewer 60 or hovers a pointer over the viewer 60.

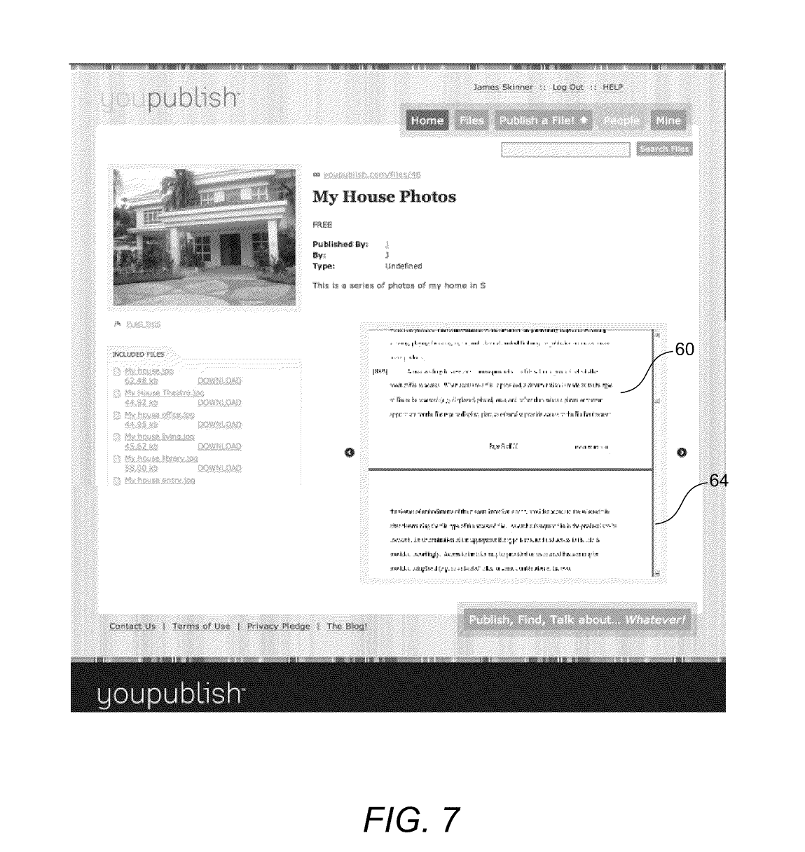

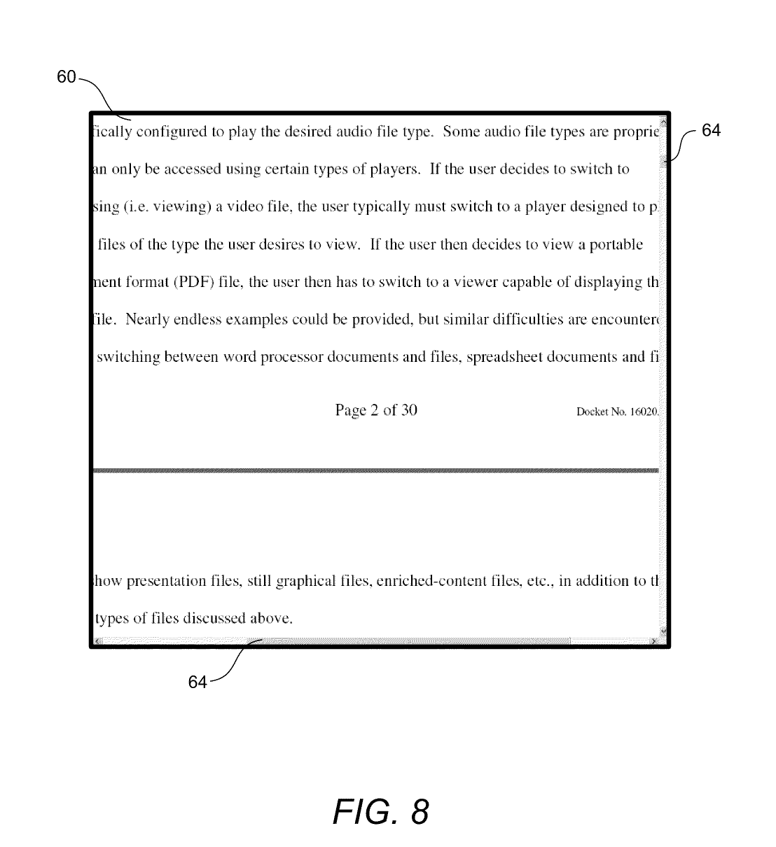

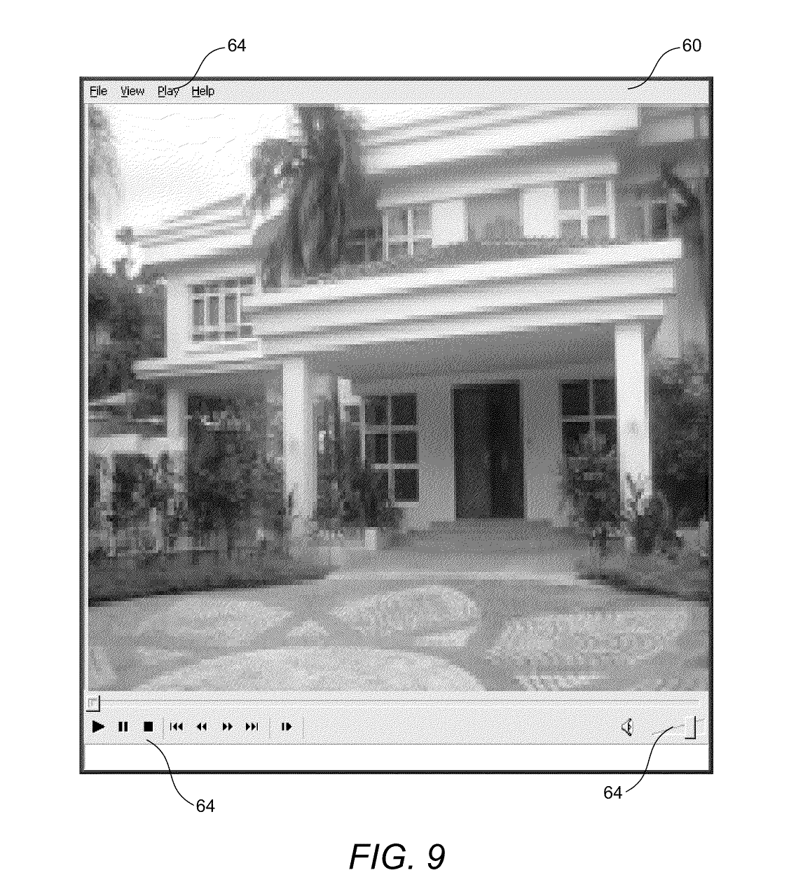

In FIG. 7, the viewer is displaying a multi-page static file type. In this case, the viewer controls 64 that are displayed include a vertical scroll bar that permits the user to scroll up/down the document to a desired location within the document. FIG. 8 shows an expanded view of an embodiment of the viewer 60 (here not illustrated as being embedded within a browser page view, although the viewer 60 illustrated may be an embedded viewer 60). In this instance, the viewer 60 has provided two viewer controls 64, a vertical scroll bar and a horizontal scroll bar to permit viewing of the entire document. FIG. 9 shows an expanded view of an embodiment of the viewer 60 displaying a video file, with appropriate viewer controls 64 provided accordingly. The illustrated examples being merely illustrative, it will be understood that a wide variety of appropriate viewer controls 64 may be provided to enhance the functionality of the viewer 60.

Although not previously discussed, some files are of a mixed nature containing both static and dynamic information. One example of such a file is a PowerPoint™ slide show that includes videos, audio clips, animations, etc. within one or more slides. The viewer 60 handles such files as any other, providing appropriate viewer controls 64 for the file as necessary to ensure adequate access to the file.

Thus, viewers 60 according to the embodiments of the invention are powerful tools for providing access to a wide variety of files, whether downloaded previously or delivered at the time of access over a network (e.g. incremental download or streaming). The access is provided without requiring that individual viewers or players be utilized for each file type, and therefore web designers and other users do not need to plan on the availability of the multiple players/viewers for access.

Although viewers 60 according to embodiments of the invention are capable of displaying, playing, or otherwise accessing a wide variety of files, the viewers 60 need not be capable of accessing every conceivable file type. Indeed, new file types are constantly being created and old file types are constantly becoming obsolete. Therefore, embodiments of the invention embrace capabilities for updating the viewer 60 to handle new/different file types. Additionally, a service provider providing files over a network may decide to convert certain file types that are not supported by the viewer 60 into one of the many file types supported by the viewer 60 when the files are uploaded to or otherwise provided by the service provider. In some instances, the original file may be maintained and made available for download and viewing/editing using an outside program as well.

Embodiments of the inventive systems and methods have been described above primarily in terms of the processes that occur to permit the viewer 60 to have the described functionality. It should be understood that the viewer 60 is provided with adequate means for accomplishing the various processes set forth above, and it should also be understood that the means for accomplishing such processes includes computer program code means and instructions on one or more computer-readable media, either pre-existing on a local computer system or delivered to a local computer system via a communications connection.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for providing in-line access to multiple file types over a network using a single viewer comprising:
providing a viewer capable of providing access to files of multiple formats that include static file formats and dynamic file formats;
receiving a selection of a selected file to access using the viewer;
determining a file type of the selected file;
determining appropriate viewer controls for the viewer to display for controlling access to the selected file; and
providing the appropriate viewer controls and the selected file through the viewer.

2. A method as recited in claim 1, wherein the viewer is embedded in a webpage and displayed by a browser.

3. A method as recited in claim 1, wherein the viewer provides access to the selected file over a network.

4. A method as recited in claim 3, wherein the viewer also provides access to an additional file that is stored locally.

5. A method as recited in claim 1, wherein the selected file is a static file, and wherein the appropriate viewer controls comprise controls selected from the group of:
pagination controls;
scrolling controls;
zoom controls; and
scaling controls.

6. A method as recited in claim 5, wherein determining appropriate viewer controls is based in part upon a determination whether the static file fits within a viewable area.

7. A method as recited in claim 5, wherein determining appropriate viewer controls is based in part upon receipt of user inputs to change a view of the static file displayed by the viewer.

8. A method as recited in claim 1, wherein the selected file is a dynamic file, and wherein the appropriate viewer controls comprise controls selected from the group of:
play;
pause;
fast-forward;
rewind;
stop;
slow-play;
frame advance/back;
volume; and
a time/progress indicator/slider.

9. A method as recited in claim 1, wherein the selected file is a dynamic file, further comprising:
determining a sampling or frame rate for outputting the selected file; and
outputting the selected file at the sampling or frame rate.

10. A method as recited in claim 1, wherein receiving a selection of a selected file to access comprises receiving selection of a plurality of files to access using the viewer, the method further comprising:
determining a file type of each of the plurality of files;
determining appropriate viewer controls for each of the plurality of files; and
providing the appropriate viewer controls for each of the plurality of files with each of the plurality of files through the viewer.

11. A method as recited in claim 10, wherein providing the appropriate viewer controls for each of the plurality of files comprises changing the viewer controls provided by the viewer as access to different files is provided.

12. A method as recited in claim 1, further comprising resizing the viewer to better provide access to the selected file.

13. A viewer for providing in-line access to multiple file types, including static and dynamic file types, over a network comprising:
means for determining a file type of each file selected for access using the viewer;
a plurality of viewer controls for controlling access to files of various types, including viewer controls for controlling access to static files and viewer controls for controlling access to dynamic files;
means for determining an appropriate subset of the plurality of viewer controls for each file type of each file selected for access; and
means for displaying the appropriate subset of the plurality of viewer controls.

14. A viewer as recited in claim 13, wherein the viewer is configured to determine different appropriate subsets of the plurality of viewer controls for multiple files to be access sequentially, and is further configured to change the displayed viewer controls as different files are accessed.

15. A viewer as recited in claim 13, wherein the viewer is configured to determine a new appropriate subset of the plurality of viewer controls based on user input received from viewer controls currently displayed, whereby user input causes a change in the displayed viewer controls.

16. A viewer as recited in claim 13, wherein the viewer is configured to be displayed within a browser.

17. A viewer as recited in claim 13, wherein the viewer is configured to be displayed as a stand-alone viewer.

18. A computer-readable medium storing computer program code means for implementing a method for providing in-line access to multiple file types over a network using a single viewer, the method comprising:
providing a viewer capable of providing access to files of multiple formats that include static file formats and dynamic file formats;
receiving a selection of a selected file to access using the viewer;
determining a file type of the selected file;
determining appropriate viewer controls for the viewer to display for controlling access to the selected file; and
providing the appropriate viewer controls and the selected file through the viewer.

19. A computer-readable medium as recited in claim 18, wherein receiving a selection of a selected file to access comprises receiving selection of a plurality of files to access using the viewer, the method further comprising:
determining a file type of each of the plurality of files;
determining appropriate viewer controls for each of the plurality of files; and
providing the appropriate viewer controls for each of the plurality of files with each of the plurality of files through the viewer.

20. A computer-readable medium as recited in claim 19, wherein providing the appropriate viewer controls for each of the plurality of files comprises changing the viewer controls provided by the viewer as access to different files is provided.

21. A computer-readable medium as recited in claim 18, wherein determining a file type of the selected file comprises one of:
examining a file extension of the selected file; and
examining other file type information included in the file.

22. A computer-readable medium as recited in claim 18, further comprising determining whether the selected file is a static file or a dynamic file.

23. A computer-readable medium as recited in claim 18, wherein the selected file includes both static content and dynamic content.

24. A computer-readable medium as recited in claim 18, further comprising disabling one or more viewer controls pending purchase of the selected file.
